(19) United States
(12) Patent Application Publication
(10) Pub. No.: US 2003/0164326 A1
(43) Pub. Date: Sep. 4, 2003

(54) Absorbent filter material matrices and their arrangements in filter cartridge

(76) Inventors: Rolf Eberl, Kincardine (CA); Adolf Eberl, Kincardine (CA); Peter Eberl, Kincardine (CA)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/326,567

(22) Filed: Dec. 20, 2002

(30) Foreign Application Priority Data
Dec. 21, 2001 (CA) 2,366,066

(51) Int. Cl. B01D 15/00

(52) U.S. Cl. 210/263; 210/295; 210/497.01

(57) ABSTRACT

A filter cartridge is described for use in a system to remove impurities from the air. The cartridge has a filter section which may provide tortuous air flow channels between an inlet and an outlet of the filter section. The filter section may be formed from a pair of adjoined sheets with at least one of the sheets having an internally directed raised pattern thereon. This raised pattern spaces the adjoined sheets. The adjoined sheets may be rolled-up into a spiral shape and are positioned in the cartridge with said sheets paralleling an air flow direction through said filter section. It is also contemplated that the raised pattern of the adjoined sheets provide linear air flow channels but ones which are less than three millimeters in height. Alternatively, the filter section may comprise an open pore sponge or foam. The cartridge may be provided with an inlet closure plate having openings therein so as to impart turbulence to incoming air.

### BACKGROUND OF THE INVENTION

This invention relates to a filter cartridge intended primarily for use in respirators and airscrubbing equipment.

To avoid inhalation of dangerous vapours, workers may be required to breathe through a respirator or other airscrubbing equipment having a filter.

Known systems use an absorbent, wet or dry, such as granular fills, molecular sieve, (pleated) filter paper or cloth or other filter material where the air flows through the porous filter media. While these systems may be very effective, they provide a very highly resistive force, opposing the airflow, resulting in a high pressure drop, which is especially detrimental and demanding when used to purify breathing air. The result is shortness of breath and little energy left for productive work. A further result is an uneven exposure of the interacting surface to the airflow in pleated absorbent porous paper filters.

Canadian Patent No. 1,265,754 to Rolf Eberl and Adolf Eberl describes several filter arrangements where the air flows around the filter material, rather than through it.

The present invention seeks to further improve filter arrangements.

### SUMMARY OF INVENTION

A filter cartridge is described for use in a system to remove impurities from the air. The cartridge has a filter section which may provide tortuous air flow channels between an inlet and an outlet of the filter section. The filter material may be formed from a pair of adjoined sheets with at least one of the sheets having an internally directed raised pattern thereon. This raised pattern spaces the adjoined sheets. The adjoined sheets are positioned in the cartridge with said sheets paralleling an airflow direction through said filter section. It is also contemplated that the raised pattern of the adjoined sheets provide linear air flow channels but ones which are less than three millimeters in height. Alternatively, the filter section may comprise an open pore sponge or foam. The cartridge may be provided with an inlet closure plate having openings therein so as to impart turbulence to incoming air.

Accordingly, the present invention provides a filter cartridge comprising: an inlet filter section comprising a water containing water reservoir; a filter section with a filter material comprising a pair of adjoined sheets, at least one of said sheets having a raised pattern thereon so as to space said adjoined sheets, said adjoined sheets positioned in said cartridge with said sheets paralleling an air flow direction through said filter section, said raised pattern providing parallel flow paths through said filter section, said raised pattern providing a spacing of less than three millimeters between said pair of adjoined sheets.

According to another aspect of the present invention, there is provided a filter cartridge, comprising: a filter section comprising an open pore sponge.

According to a further aspect of the invention, there is provided a filter cartridge comprising: a filter section with tortuous air flow channels extending between an inlet and an outlet of said filter section; an inlet closure plate having openings therein so as to impart turbulence to incoming air.

### BRIEF DESCRIPTION OF THE DRAWINGS

In the figures which describe example embodiments of the invention,

FIG. 1 is a vertical cross section of a filter cartridge, showing the location and placement of filters, spacers and diffusing shield and wicks, as well as entry and exit ports of the container,

FIG. 2 is a horizontal cross section of a filter cartridge, showing the placement of the star-shaped separator, the diffusing discs and the entry and exit ports,

FIG. 3 is a top view of a rolled up corrugated filter section with distributed wicks,

FIG. 4 is a perspective view of a lower separator, showing placement of the holes and the steps on which a deflecting disc rests and is centered,

FIG. 5 is a perspective view of a known filter section, made out of two sheets of absorbent material, one sheet is straight and one corrugated, rolled up together,

FIG. 6 is a vertical cross section of a known filter cartridge of having filter discs, with the separator strips omitted for clarity,

FIG. 7 is a broken away perspective view of one of the filter discs (26 of FIGS. 7, 8) and its positioning in a container via a double ridge,

FIG. 8 is a vertical cross section of another known filter cartridge having filter discs, with separator strips not shown for clarity,

FIG. 9 is a perspective view of a second filter disc of FIG. 8,

FIG. 10 is a perspective view of a first filter disc of FIG. 8 and part of the container, showing the double ridge and its guiding action for a disc,

FIG. 11 is a perspective view of a filter section of a filter cartridge according to a first embodiment of this invention,

FIG. 12 is a perspective view of a portion of the filter material of the filter section of FIG. 11,

FIG. 13 is a perspective view of a filter section of a filter cartridge according to a second embodiment of this invention,

FIG. 14 is a perspective view of a portion of another embodiment of filter material for a filter section,

FIG. 15 is a perspective view of a portion of a further embodiment of filter material for a filter section,

FIG. 16 is a perspective view of a filter section of a filter cartridge according to a further embodiment of this invention,

FIG. 17 is a simplified perspective view of a closure plate for the inlet side of a filter section, and

FIG. 18 is a simplified perspective view of another closure plate for the inlet side of a filter section.

### DETAILED DESCRIPTION

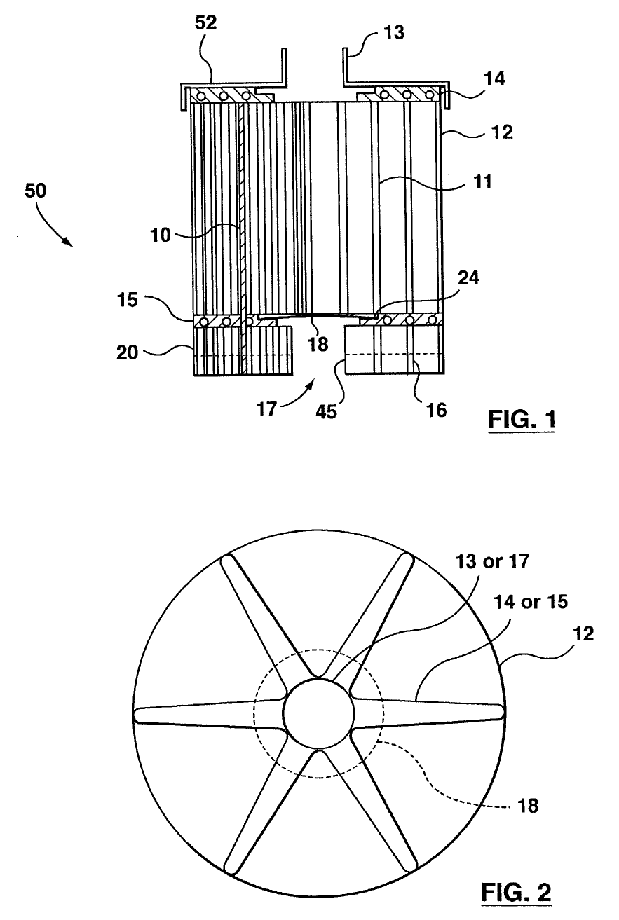

Turning to FIGS. 1 to 4, a filter cartridge 50 has, within a container (canister) 12, in downstream order, an inlet port 17 opening to a short pipe section 45 defined by an inlet filter section 16 (that functions as a water reservoir to replace lost moisture), a separator 15 with a deflection disc 18, a primary filter section 11, and a separator 14 with a top cover 52 and an outlet port 13. The base of the inlet filter section is filled with liquid to liquid level 20. Wicks 10 are distributed through, and extend between, the inlet 16 and primary 11 filter sections.

Pipe section 45 at the bottom of the container is composed of a 35 mm diameter pipe, extending upwards into the container 12 by about 50 mm resulting in a reservoir that retains the excess liquid needed to humidify the airflow and to keep the main absorbent filter 11 moist. To facilitate this, a short absorbent filter section 16 (about 50 mm high) rests on the floor of the container where the reservoir is, absorbing part of the excess liquid and retaining the balance of the not yet absorbed fluid.

Held above this lower absorbent assembly by a well perforated separator 15 (FIGS. 2 and 4) is the second (about 120 mm high) main filter section 11. The separator should preferably (but not necessarily) be star-shaped, made from a 20 mm wide band of stiff material, standing on its edge. The inner hub of the separator is a little larger in its diameter than the inlet port. The outgoing spokes of the star are notched on the upper inner edge to create a round recess, that holds in place an inverted saucer shaped diffusing disc that deflects and distributes the airflow more evenly.

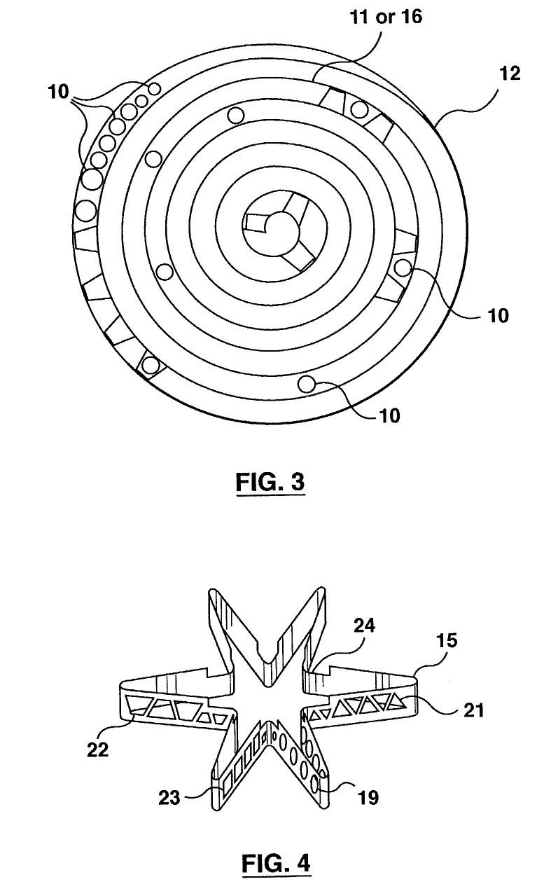

Strategically spaced wicks 10 (FIGS. 1 and 3) can be inserted in some of the corresponding channels, spanning the gap between the upper and lower absorbent filter sections, to achieve better replacement of evaporated liquid in the upper filter section.

A second separator 14, similar to the first, placed on top of the main absorbent filter 11, assures proper positioning and spacing of the main absorbent filter 11 at the top of the container 12. If a particle filter is needed, it can be fitted to the bottom of the container in an additional container, fastened airtight with tape or gasket or latch-fasteners.

The absorbent filter sections 11 and 16 are designed in such a way that they have vertically running channels.

This system can be paired with an extra particle, carbon or electrostatic filter annex.

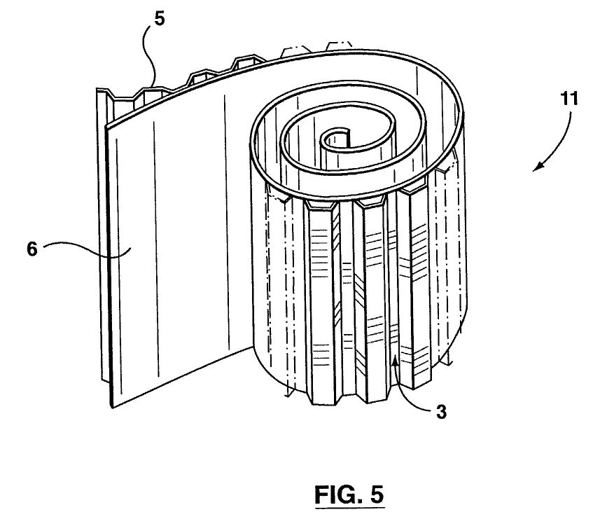

Referencing FIG. 5, the absorbent of filter section 11 (or 16) can be made from a variety of porous or fibrous materials—such as filter, blotting, ceramic paper or fiber mats from natural or synthetic origin, as well as ceramic or sintered materials, woven fabric, paper or sheet materials. The absorbent is manufactured into a matrix of a plurality of parallel channels 3, facing the airflow with its openings. This produces an airflow parallel to the surface of the channels and gives the air time to exchange vapours by defusing chemicals and removing impurities with little pressure drop.

To achieve this a corrugated 5 and a straight 6 sheet are joined together like a single-sided corrugated cardboard, by gluing, pressing, ultrasonic or diathermic welding, heatsetting, or any convenient way. The corrugation can be made sinusoidal, triangular, square or trapezoidal. The resulting corrugated absorbent is then rolled up tightly to fill the canister 12 which can be round, oval, kidney or any other convenient shape to fit the purpose. Pressed carbon, sintered materials or porous ceramic materials can also be processed the same way, or can be pressed into a solid form with fine longitudinal parallel channels (or holes) with very thin walls by a mold, to end up with a similar arrangement as the corrugated absorbent.

Some organic or synthetic fibers, once arranged into a matrix, can be carbonized completely or partially under controlled conditions as known in the art. This can be done before or after impregnation with salts, reagents, chemicals, catalysts or a mixture of two or more of the before mentioned.

In most cases the absorbent is saturated with liquids just before being put to use, to activate the filter to attract, trap, transform, diffuse or absorb vapours, chemicals or particles and impurities from the contaminated airflow.

In the case of a dry absorbent system of the corrugated variety or the solid channelled form, silicagel can be used to extract water or other fluids and vapours.

In use, the airflow enters via the entry port 17 (FIG. 1), hits the deflection disc 18, fans out and distributes through the holes in the spokes of separator 15, picks up moisture and exchanges vapours, and also loses particles as it passes through the multitude of parallel channels (FIGS. 1, 5). The slow moving air passes over the tremendously expanded surface of the channels 3 (FIG. 5), saturated with liquids or chemicals and not through the porous material itself to achieve: diffusion, exchanges, absorption, cracking, isotopic exchanges and conversions, chemical reactions or chemical conversions. The air flowing through those symmetric and well organised channels 3 of equal size and length with also cause a fairly uniform air velocity, giving the air uniform chemical exchange and reaction time.

To keep filter 11 moist, filter 16 absorbs liquid from the liquid level 20 and gives moisture off through evaporation as well as via the multitude of wicks 10 to filter 11 by capillary action. Shaking, as well as movement (while working) will also distribute the liquid. Filters 11 and 16 are manufactured from rolled up single-sided corrugated filter material or pressed carbon, sintered materials or porous ceramics as mentioned before.

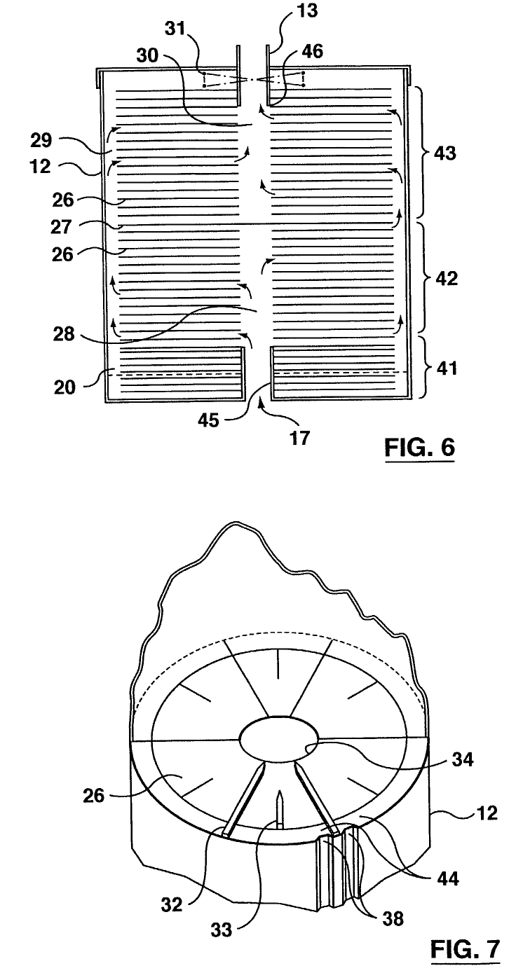

A second known arrangement illustrated in FIGS. 6 and 7, has a container 12, with inlet port 17, short pipe section 45, top cover 31 and outlet port 13 similarly to the arrangement of FIGS. 1 to 4. The canister 12 is built as in the first arrangement, except that it should be round.

The absorbent can be the same material as in the first arrangement. It can also be treated similarly, but the channels are created differently.

Three stacks of equally sized filter discs are used. Section 41 at the bottom of the container is filled with discs 26, retaining liquid and transporting the liquid from waterline 20 up to the second and actual filter pack, section 42, by capillary action. Also, the liquid sloshes by movement (such as work). Thus, the replacement of evaporated fluids from the discs 26 is accomplished by a capillary action as well as by sloshing as the user moves when working.

This filter discs of stacks 41, 42, and 43 can be manufactured as described in the first arrangement, with the same materials and the same chemical and fluid treatment, or it can also be used dry, made with silicagel. The absorbent disc material used can be made in different thicknesses, depending on the properties of the different materials, in this case it is about 1 to 2 mm. The discs are made of thin absorbent filter material, of about 100 mm to 150 mm diameter with a 35 mm hole in the middle. On top of the disc, running radially from center hole to outer edge, and evenly distributed, are a multitude (nine to fifteen) of separator strips, 32, about 3 to 6 mm wide and 1 to 3 mm high, pointed on the inside end to improve the airflow, and protruding beyond the outer edge of the disc about 6 mm to touch the walls of the round rust-proof respirator canister. The protruding separator strips will center the disc, creating a cylindrical space, 29, that surrounds the stacked filter discs, for air to flow upward to the third filter stack, section 43. Short separator strips 33 of half length are placed alternating with the long ones 32 and center the disc and separate the discs, so that air can flow through the space between discs in the stack. The shorter separator strips 33 have the same height as strips 32 and run radially to the outer edge of the disc, but not to extend beyond the outer edge. By placing the long and short separator strips respectively on top of each other (with help of the double ridge) the stack becomes more rigid and improves the capillary action of the stack.

The second stack, section 42 is terminated by disc 27, with the same construction as disc 26 but without the center hole so as to cover the distribution chamber 28.

Because of disc 27, the air in section 42 has to flow radially outwards through the multitude of fine channels created by the stacked discs and their separators.

The air coming through the input port at the bottom flows up into the distribution chamber, 28. From there the air enters all the spaces between the discs of stack 42 and will flow radially outward to join again in the cylindrical airspace 29, surrounding all the discs, 26 and 27. Flowing up space 29 until it reaches stack 43, the air enters the spaces between the filter discs of stack 43, flowing radially inward, joining again in the collecting chamber 30, to exit via the outlet port 13.

If the porous filter material used for the discs will not sag or soften and the container is fully packed without slack, the spring 31 may not be necessary. Otherwise spring 31 compresses the discs downwardly and takes up the slack.

As in the first arrangement, in the second arrangement the chemical exchanges, diffusions, vapour exchanges and all other air cleaning reactions can be the same and occur as the air flows along the porous, absorbent filter material—and not through it.

As in the first arrangement, a particle filter can be added to the inlet side of the canister.

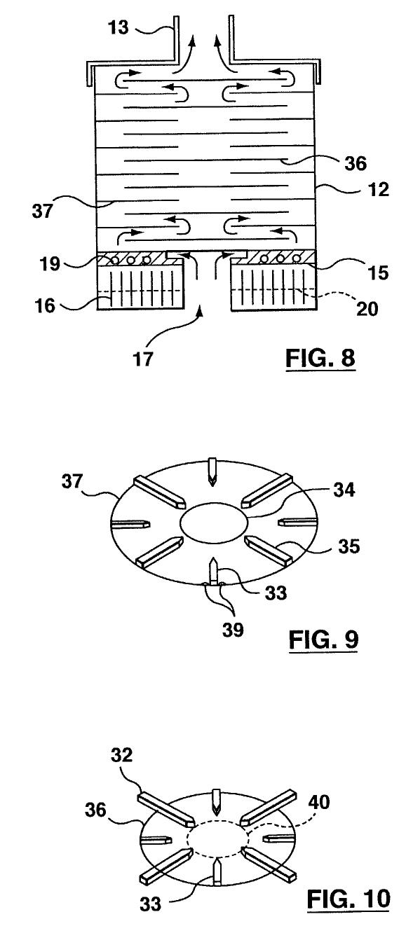

In a third known arrangement shown in FIGS. 8 to 10, the same filter materials and reactions can be used as in the first two arrangements. The container 12 is the same as in FIG. 6. The reservoir is filled as in FIG. 1 with a rolled up single-sided corrugated filter 16 with a separator 15 (with holes 19) as in FIG. 1. On top of the perforated, star-shaped separator is a stack of filter discs, composed of two different discs 37, detailed in FIG. 9, and 36, detailed in FIG. 10.

Discs 36 and 37, FIG. 9 and FIG. 10, are made similarly to disc 26 of FIG. 7, with the difference that separator strips 32, 33 and 35 are made thicker, about 3 mm to 6 mm high, depending on the results to be achieved. Also filter disc 36, FIG. 10 has no center hole. Disc 37, FIG. 9 is bigger and the thin filter material extends out to and 1 mm beyond the edge of the separators 33 and 35, which are the exact diameter of the container minus ½ mm. This produces a snug fit and keeps air from flowing past.

The first disc of the stack is of the smaller disc type, 36, followed by the larger disc, 37, and alternating thus all the way to the exit port. It is of no importance which type of disc tops the filter stack. The double notch 39 on disc 37, as well as separator 32 of FIG. 10 on disc 36 and the double ridge 38 (FIG. 7) keep the separator strips aligned one over the other.

Thus, the absorbent filter disc stack is composed alternately of discs with a 35 mm hole in the center and the outside diameter the same as in the cylindrical container and smaller filter disc 36 with no hole in the center. In this arrangement, the larger disc 37 has about 6 mm wide and 6 mm high separator strips on top, spaced equally and running radially outward from the hole to the outer edge. The second disc is about 12 mm smaller in its diameter than the container, with 6 mm wide and high separator strips, running radially from an imaginary inner circle of about 35 mm diameter and protruding over the outer edge by 6 mm centering the smaller disc. Aligning the alternating discs, so that the spacing separator strips come to rest on top of each other, can be accomplished by a double ridge running down one side of the inside of the container, 6 mm apart, to accommodate one of the separator strips of the discs. On the larger discs 37 a small notch 39 (FIG. 9) on either side on one of the separator strips 33 will locate on the double ridge 38 (FIG. 7).

The air entering at 17, flowing through separator 15 and through holes 19, picks up moisture from absorbent fill 16, hits the wall and turns to flow inward between disc 36 and disc 37, entering the hole of disc 37 and passes radially outward between the first disc 37 and the second disc 36, alternately flowing in and out, till reaching the top and exiting via the outlet port. All chemical and physical air cleaning action is the same as in the first two arrangements.

In this system of alternating absorbent filter discs, the air coming through the bottom entry port has to “weave” its way in and out through the alternating discs, accomplishing a longer interaction between the flowing air and the parallel surfaces of the absorbent. By choosing the right number of discs and the right separation of the discs one can balance out the right compromise between pressure drop and air cleaning efficiency.

As in the first two arrangements, the bulk of the air does not flow through the holes in the porous filter material, but parallel to the filter media. After flowing through all of the stacked discs, the air exits via the outlet port at the top of the container.

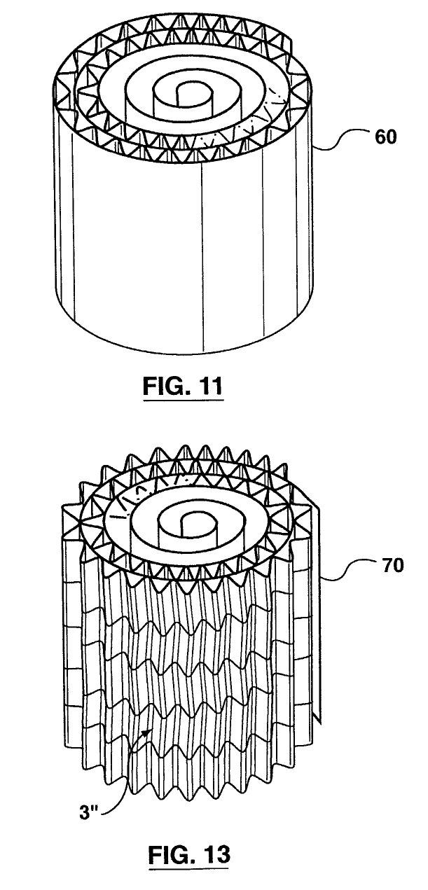

The filter sections of the described arrangements may be changed to improve the efficiencies of the canister filter system. More specifically, filter sections 11 and/or 16 may be replaced by the filter section 60 of FIGS. 11 and 12. Filter section 60 is fabricated in the same way as described for filter section 11 of FIG. 5 and is inserted into a filter canister 12 (FIG. 1) such that its channels 3′ parallel the air flow through the canister. However, the channels 3′ of the filter section 60 are made smaller. More particularly, the channels are made as microgrooves to increase the surface area of the filter that any given volume of air is in contact with as it passes through the filter. Previous arrangements use channels approximately 3 mm thickness from layer to layer. The microgroove arrangement requires that the layer to layer distance be less than 3 mm (dimension “X”, FIG. 12).

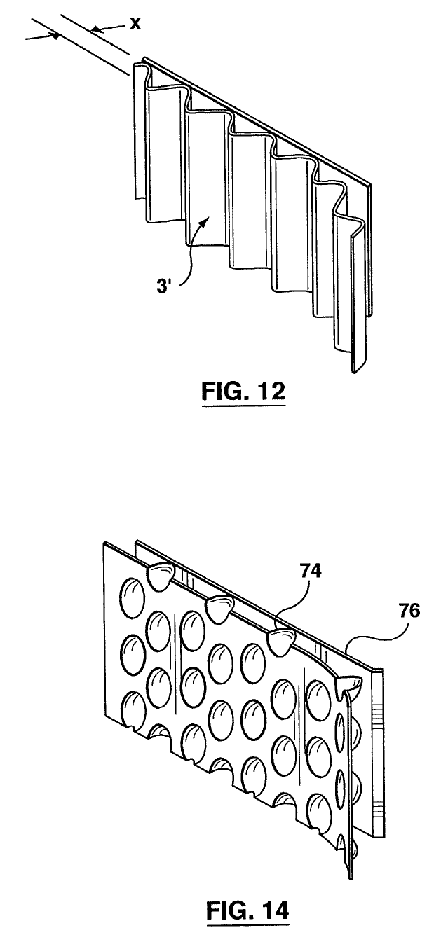

In a variation illustrated in FIG. 13, the microgrooves 3″ of filter section 70 have multiple changes in direction such as are created with zig-zag channels or other patterns which generate turbulence in the air as it passes through the filter medium.

Rather than fabricating filter section 60 as a back sheet joined to a corrugated sheet, a modified filter section may be fabricated as illustrated in FIG. 14. Dimples 74 may be pressed into the sheet stock used to form the filter matrix to cause the adjoining surfaces to be spaced away from the separating layer 76 as to create a gap between layers.

Optionally, dimples (as in FIG. 14) may be pressed into the sheet stock and adjoined to another layer with offset dimples to form the filter matrix through which the air must pass with layers spaced by the dimples from adjoining surfaces to create the channels.

Also, other raised patterns may be pressed into the sheet used to form the filter matrix to cause the adjoining surfaces to be spaced away from the adjoining layers to create channels with increased turbulence and to increase the contact the air has as it passes through in its passage through the filter.

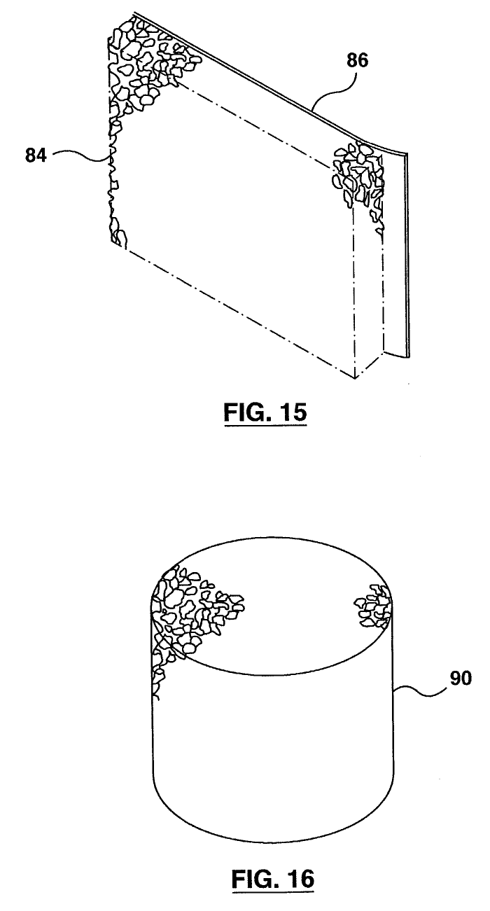

As a further option, filter section 60 may be fabricated of an open pore sponge or foam 84 adhered to a separator sheet 86 as in FIG. 15 made of an absorbent foam through which air can flow in random and turbulent fashion past surfaces of sponge. It will be appreciated that the sponge material may be of a man-made or natural fibre such as paper, cellulose, or other plant fibre formed in to a self-supporting lattice through which air can flow. The separator sheet may be impregnated with the water or other solution.

In FIGS. 11 and 13, the sheets of the filter material is illustrated as being rolled up into a spiral. As described, this filter material is then positioned in the canister 12 so that the sheets parallel the airflow direction through the filter section. However, as will be obvious to one skilled in the art, equally, individual sheets of filter material could be stacked side-by-side and positioned edge on to the direction of the air flow so as provide sheets which parallel the airflow direction through the filter section.

A filter material having dimples or other raised patterns as described, or a filter material having the described open pore sponge adhered to a back sheet, may also be used as the filter material for the disc filters 26 of FIG. 6 or 36 or 37 of FIGS. 8 to 10.

With reference to FIG. 16, filter sections 11 or 16 may also be replaced with a filter section 90 being an artificial open pore sponge made of an absorbent foam through which air can flow in random and turbulent fashion past surfaces of sponge impregnated with the water or other solution.

More generally, it has been recognised that a filter matrix manufactured of a paper-like material, or paper thin sheet of man-made material, which due to fibers or surface preparation, increases the surface area exposed and turbulence of the tritiated water vapour as it passes through the filter provides enhanced efficiency.

Also, by the expedient of increasing the length of the filter section of FIG. 1, 6, or 8 to provide a path length of twenty millimeters or more, higher efficiencies may be obtained than previously known.

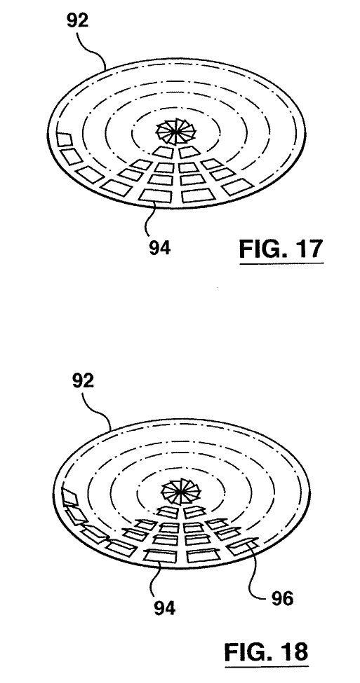

Optionally, a closure plate 92 (FIG. 17) may be provided on the inlet side of the filter section. The closure plate has small openings 94 which enhance the turbulence of the in-rushing air and, therefore, increase filter efficiency. Turbulence might be even further increased by providing irregularly shaped small openings in the closure plate. Alternatively, turbulence may be increased by providing deflectors 96 associated with the openings 94, in the closure plate 92′ shown in FIG. 18.

The openings in the closure plate may be punch formed or otherwise formed.

The filter medium may be impregnated with activated charcoal or other substance to increase the shelf life or suppress the growth of bacteria or moulds on the filter matrix.

Filters of the described arrangements are specially suited for the removal of tritiated water vapours, isotopic exchanges and catalytic reactions. For example 99.8% of tritiated water vapours have been removed during a two hour period.

As will be apparent to those skilled in the art, optionally, any of the described filter cartridges may be manufactured without the inlet filter section 16 (i.e., the cartridges may not have a water reservoir).

Other modifications than those described will be apparent to those skilled in the art and, therefore, the invention is defined in the claims.

What is claimed is:

1. A filter cartridge comprising:
an inlet filter section comprising a water containing water reservoir;
a filter section with a filter material comprising a pair of adjoined sheets, at least one of said sheets having a raised pattern thereon so as to space said adjoined sheets, said adjoined sheets positioned in said cartridge with said sheets paralleling an air flow direction through said filter section, said raised pattern providing parallel flow paths through said filter section, said raised pattern providing a spacing of less than three millimeters between said pair of adjoined sheets.

2. The filter cartridge of claim 1 wherein said raised pattern provides tortuous parallel flow paths through said filter section.

3. The filter cartridge of claim 2 wherein said tortuous path is a zig-zag path.

4. The filter cartridge of claim 1 wherein said raised pattern comprises dimples.

5. The filter cartridge of claim 4 wherein said dimples are on one of said sheets and said adjoined sheet is a plain sheet.

6. The filter cartridge of claim 4 wherein said dimples are on both of said sheets, with dimples of one of said sheets being offset from dimples of another of said sheets.

7. The filter cartridge of claim 1 wherein said adjoined sheets are rolled-up into a spiral.

8. The filter cartridge of claim 1 further comprising an inlet closure plate having openings therein so as to impart turbulence to incoming air.

9. The filter cartridge of any of claim 1 wherein a medium of said filter section is impregnated with a bacterial suppressant.

10. The filter cartridge of claim 9 wherein said bacterial suppressant is activated charcoal.

11. A filter cartridge, comprising:
a filter section comprising an open pore sponge.

12. The filter cartridge of claim 11 wherein said filter section comprises a backing sheet to which said open spore sponge is adhered, said backing sheet with adhered sponge positioned in said cartridge with said backing sheet paralleling an air flow direction through said filter section.

13. The filter cartridge of claim 12 wherein said backing sheet with adhered sponge is rolled-up into a spiral shape.

14. A filter cartridge comprising:
a filter section with tortuous air flow channels extending between an inlet and an outlet of said filter section;
an inlet closure plate having openings therein so as to impart turbulence to incoming air.

15. The filter cartridge of claim 14 wherein said closure plate openings are irregularly shaped.

16. The filter cartridge of claim 14 wherein said closure plate openings have associated air deflectors.

17. The filter cartridge of any of claim 14 further comprising:
a reservoir section containing a liquid for wetting said filter section.
